(19) United States
(12) Patent Application Publication
(10) Pub. No.: US 2012/0148190 A1
(43) Pub. Date: Jun. 14, 2012

(54) Optical module and optical transmission device using the same

(75) Inventor: Takemasa Tamanuki, Hong Kong (CN)

(73) Assignee: SAE Magnetics (H.K.) Ltd., Hong Kong (CN)

(21) Appl. No.: 12/929,997

(22) Filed: Mar. 1, 2011

(30) Foreign Application Priority Data
Dec. 10, 2010 (CN) 201010581899.2

(51) Int. Cl. G02B 6/32

(52) U.S. Cl. 385/33

(57) ABSTRACT

There is provided an optical waveguide device including a light-emitting element having a light-emitting part for emitting a laser beam and a light-receiving element having a light-receiving part for receiving a laser beam, the elements being arranged on a mounting substrate in parallel with each other; and a first lens for optically coupling the laser beam emitted from the light-emitting part to a first optical waveguide core and a second lens for optically coupling the laser beam conducted through a second optical waveguide core to the light-receiving part, the lenses being arranged in parallel with each other, and in the optical waveguide device. The light-emitting element is a surface light-emitting semiconductor laser having a transparent semiconductor substrate laminated with an active layer as the light-emitting part, the surface light-emitting semiconductor laser emitting the laser beam from the active layer through the transparent semiconductor substrate. In the case where the surface light-emitting semiconductor laser and the light-receiving element are placed on a flat surface, when the active layer and the light-receiving part differ from each other in height with respect the flat surface, the optical waveguide device is configured so that the active layer is located at a focus position of the first lens and the light-receiving part is located at a focus position of the second lens.

### TECHNICAL FIELD

The present invention relates to an optical waveguide device for optically coupling a light beam emitted from a light-emitting element to a waveguide core by means of a lens and optically coupling a light beam conducted from a waveguide core to a light-receiving element by means of a lens. The present invention also relates to an optical transmission device using the optical waveguide device.

### BACKGROUND ART

In recent years, with higher performances of electronic apparatuses, it has become difficult to increase data transmission rate and reduce noises with electric wiring. For this reason, attention is being given to optical wiring between the electronic apparatuses or between boards or chips in the electronic apparatus. In order to realize the optical wiring, a surface light-emitting element (VCSEL (Vertical Cavity Surface Emitting LASER)) having excellent rapidity and mass productivity has been used for interconnection and optical communication. Such light-emitting element has been combined with an optical waveguide device to be modularized.

Such optical transmission module may adopt the VCSEL having a semiconductor substrate that is transparent for a used laser beam of certain wavelength range in terms of rapidity, heat radiation performance and mass productivity. Since the semiconductor substrate is transparent for the laser beam of certain wavelength range, the VCSEL can output the laser beam through the semiconductor substrate. For this reason, it is possible to arrange the VCSEL so that its active layer faces a module mounting substrate, which is advantageous for a heat radiation performance. In addition, as distinct from a VCSEL from which a laser beam is emitted without passing through the semiconductor substrate, this type of VCSEL can be manufactured without concern for the accuracy of an electrode formed on a laser beam emission opening, thus enabling mass production.

An example of the optical transmission module is disclosed in Patent document 1. According to an art disclosed in Patent document 1, semiconductor substrates of a light-emitting element and a light-receiving element each face a module mounting substrate. That is, the substrates of these elements are bonded to the module mounting substrate. A 45-degree mirror for converting optical paths is also used. Although not shown in Patent document 1, there is a generally-known method of improving an optical coupling efficiency by disposing a lens for optically coupling the light-emitting element to an optical waveguide and a lens for optically coupling the light-receiving element to the optical waveguide on both the element mounting side and the optical waveguide side in the 45-degree mirror.

[Patent document 1] Unexamined Patent Publication No. 2010-8482

### SUMMARY OF THE INVENTION

However, in the case of using the above-mentioned VCSEL having the transparent semiconductor substrate, when the active layer (P/N junction interface) is arranged so as to face the module mounting substrate, a distance between the active layer of the VCSEL and the lens surface is different from a distance between a light-receiving surface of the light-receiving element and the lens surface. That causes a problem one optical coupling decreases. That is, the VCSEL having the transparent substrate and the light-receiving element cannot be optically coupled to respective optical waveguides simultaneously and appropriately, disadvantageously generating an optical coupling loss and degradation of performances. Especially to achieve high-speed data transmission in an optical communication link, it is an important factor to prevent lowering of receiving sensitivity. For this reason, it is need to prevent deterioration of performances due to the optical coupling loss in the optical transmission module as much as possible.

An object of the present invention is to solve the above-mentioned problems, that is, deterioration of performances due to generation of the optical coupling loss in the optical waveguide device.

To achieve the above-mentioned object, an optical waveguide device according to an aspect of the present invention includes:

a light-emitting element having a light-emitting part for emitting a laser beam and a light-receiving element having a light-receiving part for receiving a laser beam, the elements being arranged on a mounting substrate in parallel with each other; and

a first lens for optically coupling the laser beam emitted from the light-emitting part to a first optical waveguide core and a second lens for optically coupling the laser beam conducted through a second optical waveguide core to the light-receiving part, the lenses being arranged in parallel with each other, and in the optical waveguide device,

the light-emitting element is a surface light-emitting semiconductor laser having a transparent semiconductor substrate laminated with an active layer as the light-emitting part, the surface light-emitting semiconductor laser emitting the laser beam from the active layer through the transparent semiconductor substrate,

in the case where the surface light-emitting semiconductor laser and the light-receiving element are placed on a flat surface, and the active layer and the light-receiving part differ from each other in height with respect the flat surface, the optical waveguide device is configured so that the active layer is located at a focus position of the first lens and the light-receiving part is located at a focus position of the second lens.

In the optical waveguide device according to the present invention, the equipped light-emitting element is the surface light-emitting semiconductor laser that has the transparent semiconductor substrate laminated with an active layer as the light-emitting part, and allows the laser beam to be passed through the transparent semiconductor substrate and emitted from the active layer. In the state where the light-emitting element and the light-receiving element are placed on the flat mounting substrate, the active layer of the surface light-emitting semiconductor laser and the light-receiving part of the light-receiving element differ from each other in height. However, according to the present invention, even when such surface light-emitting semiconductor laser as the light-emitting element and light-receiving element are used, positions and structures of the surface light-emitting semiconductor laser, the light-receiving element and the lenses are adapted so that the active layer as the light-emitting part is located at the focus position of the first lens and the light-receiving part is located at the focus position of the second lens. Thereby, the optical coupling loss in the surface light-emitting semiconductor laser and the light-receiving element can be suppressed. Therefore, because the surface light-emitting semiconductor laser with the above-mentioned configuration can be used, high-speed transmission can be achieved. Further, since the active layer as the light-emitting part is located on the mounting substrate side, it is possible to provide an optical waveguide device that can suppress the optical coupling loss as well as improve its performances while improving a heat radiation performance.

In the optical waveguide device,

the first lens and the second lens have the same surface curvature radius and lie in the same plane, and

by mounting the surface light-emitting semiconductor laser and the light-receiving element on the mounting substrate in different heights, the active layer of the surface light-emitting semiconductor laser and the light-receiving part of the light-receiving element lie in the same plane and have the same distance from the respective lenses.

In the optical waveguide device,

a spacer having a predetermined thickness is provided between the surface light-emitting semiconductor laser and the mounting substrate, and

the spacer is an electrical insulating material that is highly thermal conductive, and a conductive pattern electrically connected to the surface light-emitting semiconductor laser is formed on a surface of the spacer, on which the surface light-emitting semiconductor laser is mounted.

In the optical waveguide device,

in the mounting substrate, a region where the light-receiving element is mounted is depressed from a region where the surface light-emitting semiconductor laser is mounted.

By mounting the surface light-emitting semiconductor laser as the light-emitting element and the light-receiving element on the mounting substrate in different heights in this manner, the active layer is located at the focus position of the first lens and the light-receiving part is located at the focus position of the second lens as described above. Therefore, the optical coupling loss in the surface light-emitting semiconductor laser and the light-receiving element can be suppressed, thereby improving the performances of the optical waveguide device.

As an example, by placing the spacer having the predetermined thickness on the mounting substrate and mounting the surface light-emitting semiconductor laser on the spacer, the active layer of the surface light-emitting semiconductor laser and the light-receiving part of the light-receiving element can be laid in the same plane with simple configuration. Moreover, by adopting the spacer made of a material that is highly thermal conductive, the heat radiation performance can be further improved. As another example, by mounting the light-receiving element on the recessed part of the mounting substrate, the active layer of the surface light-emitting semiconductor laser and the light-receiving part of the light-receiving element can be lied in the same plane with simple configuration and moreover, the overall height can be decreased, achieving reduction of the device in size.

In the optical waveguide device,

the light-receiving element is a photodetector having a transparent semiconductor substrate laminated with the light-receiving part, the photodetector allowing the light-receiving part to receive a laser beam emitted through the transparent semiconductor substrate,

the first lens and the second lens have the same surface curvature radius and lie in the same plane, and

by mounting the surface light-emitting semiconductor laser and the light-receiving element in the same plane on the mounting substrate, the active layer of the surface light-emitting semiconductor laser and the light-receiving part of the light-receiving element lie in the same plane and have the same distance from the respective lenses.

In the optical waveguide device,

the surface light-emitting semiconductor laser and the light-receiving element are mounted in the same plane on the mounting substrate,

the first lens and the second lens have the same surface curvature radius, the mounting substrate, and

by arranging the lenses in different heights from the mounting substrate, the active layer is located at the focus position of the first lens and the light-receiving part is located at the focus position of the second lens.

In the optical waveguide device,

the surface light-emitting semiconductor laser and the light-receiving element are mounted in the same plane on the mounting substrate,

the first lens and the second lens have different surface curvature radii,

by mounting the surface light-emitting semiconductor laser and the light-receiving element on the mounting substrate in the same height, the active layer is located at the focus position of the first lens and the light-receiving part is located at the focus position of the second lens.

As described above, the light-emitting element and the light-receiving element are formed of the surface light-emitting semiconductor laser and the photodetector that each have the transparent semiconductor substrate, respectively, and the surface light-emitting semiconductor laser and the photodetector are mounted in the same plane of the mounting substrate. Thereby, the light-emitting part and the light-receiving part are located at the focus positions of the corresponding lenses, respectively, suppressing the optical coupling loss. Even when the light-emitting element and the light-receiving element are mounted in the same plane of the mounting substrate and the light-emitting part and the light-receiving part differ from each other in height, by adjusting heights of the lenses from the mounting substrate and the curvature radii of the lenses, the light-emitting part and the light-receiving part are located at the focus positions of the corresponding lenses, respectively, suppressing the optical coupling loss.

According to the present invention, with the above-mentioned configuration, the light-emitting part and the light-receiving part are located at the focus positions of the corresponding lenses, respectively. As a result, the optical coupling loss in the optical waveguide device can be suppressed, thereby improving the performances of the device.

### BRIEF DESCRIPTION OF DRAWINGS

FIG. 1A is a side view showing configuration of an optical waveguide device related to the present invention;

FIG. 1B is a front view showing the configuration of the optical waveguide device related to the present invention;

FIG. 2 is a front view showing the configuration of another optical waveguide device related to the present invention;

FIG. 3 is a front view showing configuration of an optical waveguide device in accordance with First embodiment of the present invention;

FIG. 4 is a front view showing configuration of an optical waveguide device in accordance with Second embodiment of the present invention;

FIG. 5 is a front view showing configuration of an optical waveguide device in accordance with Third embodiment of the present invention;

FIG. 6 is a front view showing configuration of an optical waveguide device in accordance with Fourth embodiment of the present invention; and

FIG. 7 is a front view showing configuration of an optical waveguide device in accordance with Fifth embodiment of the present invention.

### DETAILED DESCRIPTION OF PREFERRED EMBODIMENTS

### First Embodiment

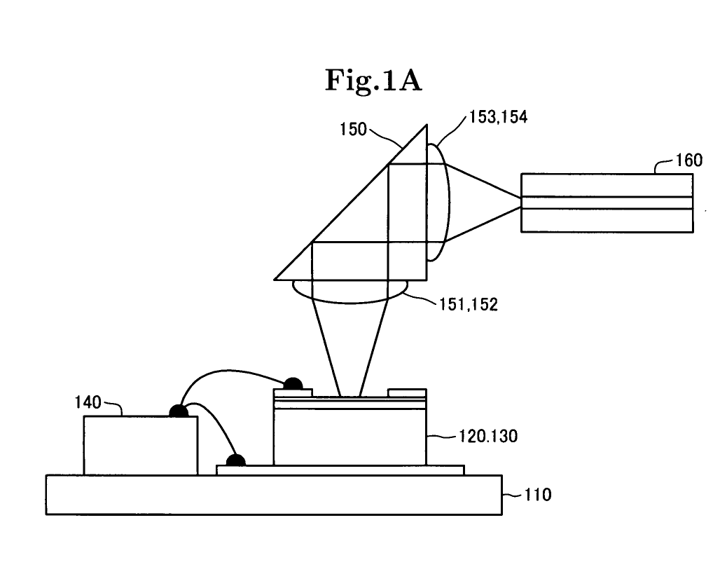

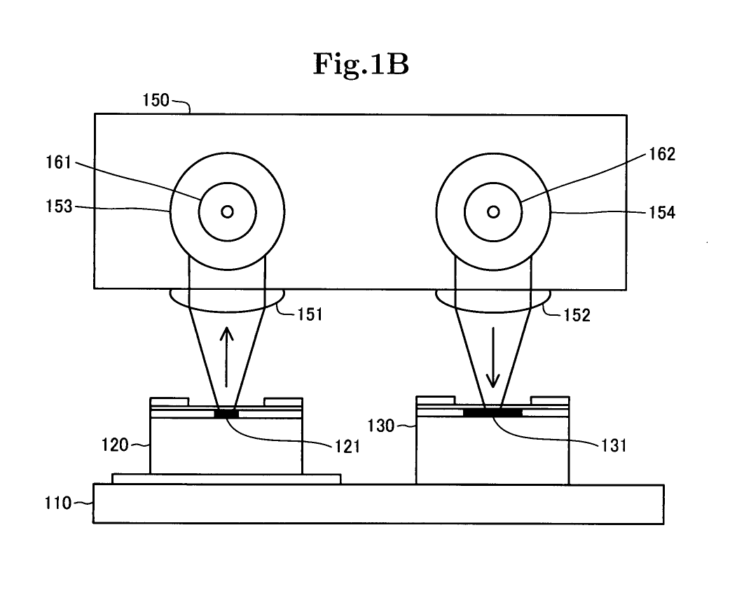

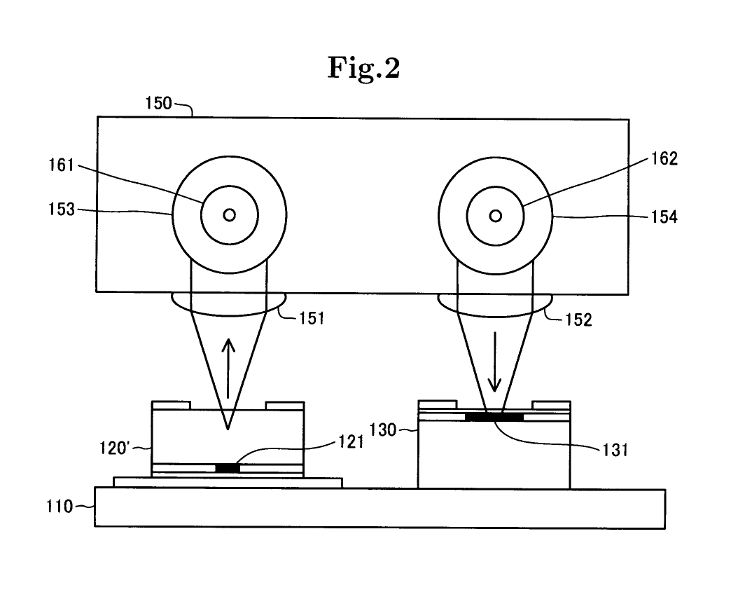

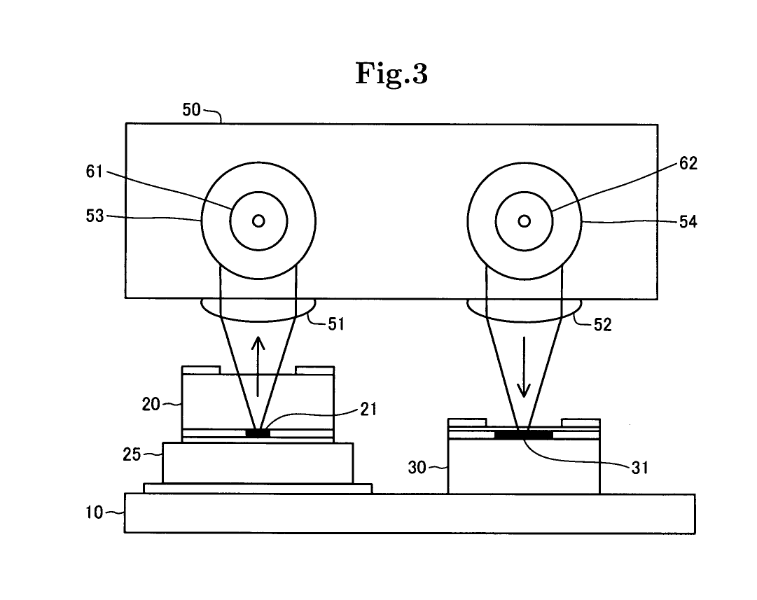

First embodiment of the present invention will be described below with reference to FIG. 1A to FIG. 3. FIG. 1A to FIG. 2 are views showing configuration of optical waveguide devices related to the present invention and FIG. 3 is a view showing configuration of an optical waveguide device in this embodiment.

The optical waveguide device according to the present invention includes a light-emitting element, a light-receiving element, a first lens for optically coupling a laser beam outputted from the light-emitting element to a first optical waveguide core and a second lens for optically coupling a laser beam transmitted from a second optical waveguide core to the light-receiving element. The optical waveguide device further includes a driver circuit for controlling a light-emitting operation and a light-receiving operation to constitute an optical transmission module (optical transmission device).

Hereinafter, the optical waveguide device will be described in detail. First, description will be made to basic configuration of a transmission module using the optical waveguide device with reference to FIG. 1A and FIG. 1B, and then, to problems of the optical waveguide device with reference to FIG. 2. Subsequently, configuration of the optical waveguide device in this embodiment will be described with reference to FIG. 3.

FIG. 1A and FIG. 1B are views showing configuration of the optical transmission module. FIG. 1B is a front view of the optical transmission module and FIG. 1A is a front view of the optical transmission module. As shown in these figures, in the optical transmission module, a light-emitting element 120, a light-receiving element 130 and a driver IC (circuit) 140 are mounted on an optical transmission module substrate 110 (mounting substrate).

The light-emitting element 120 is, for example, a VCSEL 120 as a surface light-emitting semiconductor laser. The VCSEL 120 has an active layer 121 as a light-emitting part laminated with a substrate and emits a laser beam from the active layer 121. The light-receiving element 130 is a photodetector 130 having a light-receiving surface 131 (light-receiving part) that receives the incident laser beam. The VCSEL 120 and the photodetector 130 in FIGS. 1A and 1B are bonded to the mounting substrate 110 with their substrate sides down.

The driver IC 140 is a driver circuit that drives operations of the VCSEL 120 and the photodetector 130, and is bonded to the mounting substrate 110 of the optical transmission module. Specifically, the driver IC 140 includes a drive circuit that receives a voltage signal for modulating a laser beam and driving the VCSEL 120 and a conversion circuit that converts a current signal converted from the laser beam received by the photodetector 130 into a voltage signal.

As shown in FIG. 1A, the optical transmission module further includes an optical fiber array 160 formed of optical fibers 161, 162 having the first and second optical waveguide cores for transmitting the laser beam, respectively. A 45-degree mirror 150 equipped with an array of lenses 151 to 154 is used for optical coupling to the optical fibers 161, 162. However, the 45-degree mirror 150 is not necessarily provided and other structure for converting optical paths between the VCSEL 120 and the optical fibers 161, and between the photodetector 130 and the optical fiber 162 may be equipped. Alternatively, the optical paths between the VCSEL 120 and the optical fibers 161, and between the photodetector 130 and the optical fiber 162 need not be converted.

Specifically, among the array of lenses 151 to 154, the lens 151 located above the VCSEL 120 is arranged so as to focus on the active layer 121 of the VCSEL 120. That is, the lens 151, as shown by an arrow in FIG. 1B, optically couples the light beam emitted from the active layer 121 to the waveguide core of the optical fiber 161 (first optical waveguide core) through the mirror and lens 153. The lens 152 located above the photodetector 130 is arranged so as to focus on the light-receiving surface 131 of the photodetector 130. That is, the lens 152, as shown by an arrow in FIG. 1B, optically couples the laser beam transmitted from the waveguide core of the optical fiber 162 (second optical waveguide core) to the light-receiving surface 131 through the mirror and the lens 154.

In the example shown in FIG. 1A and FIG. 1B, the VCSEL 120 and the photodetector 130 are placed on a flat surface of the mounting substrate 110 in parallel with each other, resulting in that the active layer 121 and the light-receiving surface 131 lie in the same plane. The lenses 151,152 located above the VCSEL 120 and the photodetector 130, respectively, have the same surface curvature radius and lie in the same plane. Accordingly, a distance between the VCSEL 120 and the lens 151 is equal to a distance between the photodetector 130 and the lens 152, and the active layer 121 and the light-receiving surface 131 are located at focus positions of the lenses 151, 152, respectively.

In the optical transmission module for interconnection, a GaAs/GaAlAs VCSEL of an oscillation wavelength of 850 nm is mainly used as the light-emitting element to realize a high-speed data rate up to 10 Gb/s. However, there is a demand for further increase in the data rate (ex. 25 Gb/s, 30 Gb/s, 40 Gb/s) and a more rapidly-operating VCSEL.

With the above-mentioned configuration using a GaAlAs/GaAs quantum well, it is difficult to achieve high speed of 10 Gb/s or higher. A VCSEL with a GaAs/GaInAs strained quantum well in an oscillation wavelength range from 0.98 gm to 1.1 μm (980 nm to 1100 nm) enables a high-speed operation of 20 Gb/s to 30 Gb/s. This is due to that use of the strained quantum well can decrease the effective mass of carrier (that is, Electron and Hole) in the active layer, thereby increasing the mobility of Hole and thus, enabling a high-speed operation.

Further, in this VCSEL with the GaAs/GaInAs strained quantum well, because a GaAs semiconductor substrate is transparent for a light beam in the oscillation wavelength range from 980 nm to 1100 nm, as distinct from the case of the above-mentioned VCSEL having the oscillation wavelength of 850 nm, a laser beam can be outputted from the GaAs substrate side. Thus, as shown in FIG. 2, a GaAs/GaInAs VCSEL 120′ can be bonded to the mounting substrate 110 of the optical module with the P/N junction interface side down, that is, with the substrate side up. Then, since in the VCSEL 120′, the active layer 121, that is, P/N junction serves as a heat source, by bonding the VCSEL 120′ to the mounting substrate 110 of the optical module with the P/N junction interface side down in this manner, it is possible to obtain a reduced thermal resistance, a good heat radiation efficiency and an excellent high-temperature operation.

However, as shown in FIG. 2, in the GaAs/GaInAs VCSEL 120′, a distance between the active layer 121 (P/N junction interface) of the VCSEL 120′ and the lens 151 is different from a distance between the light-receiving surface 131 (P/N junction interface) of the photodetector 130 and the lens 152. In other words, in the state where the optical module is placed on a flat surface, the active layer 121 (P/N junction interface) of the GaAs/GaInAs VCSEL 120′and the light-receiving surface 131 (P/N junction interface) of the photodetector 130 differ from each other in height. In this case, either the active layer 121 or the light-receiving surface 131 is not located at the focus position of the lens 151 or 152, resulting in that optical coupling decreases (degrades). This cause a problem that the VCSEL 120′ and the photodetector 130 cannot be optically coupled to the respective optical fibers simultaneously and appropriately.

To solve the above-mentioned problem, First embodiment of the present invention adopts such configuration as shown in FIG. 3. As shown in FIG. 3, the optical transmission module (optical waveguide device) in this embodiment like the above-mentioned optical transmission module, includes a VCSEL 20 and a photodetector 30 that are mounted on a mounting substrate 10 and a 45-degree mirror 50 equipped with lenses 51 to 54 for optical coupling to optical fibers 61, 62. Although not shown, a driver IC for driving the VCSEL 20 and the photodetector 30 is mounted on the mounting substrate 10.

In this embodiment, as in the case shown in FIG. 2, the VCSEL 20 has a GaAs/GaInAs active layer 21. A P/N junction interface side of the VCSEL 20 is bonded to the mounting substrate 10 and a laser beam is emitted from the side of a substrate of the VCSEL 20. On the contrary, a P/N junction interface side of the photodetector 30 is located on the opposite side to the mounting substrate 10. Accordingly, in the state where the VCSEL 20 and the photodetector 30 are placed on a flat surface, the active layer 21 (P/N junction interface) of the VCSEL 20 and a light-receiving surface 31 (P/N junction interface) of the photodetector 30 differ from each other in height and thus, do not lie in the same plane.

For this reason, in this embodiment, a spacer 25 having a predetermined thickness is provided between the mounting substrate 10 and the VCSEL 20. The spacer 25 is made of an electrically-insulating material that is highly thermal conductive, such as, aluminum nitride (ALN), ceramic or silicon (Si). A conductive pattern electrically connected to the VCSEL 20 is formed on a surface of the spacer 25, on which the VCSEL 20 is mounted. Thereby, the mounting substrate 10 is electrically connected to the VCSEL 20 via the spacer 25.

The thickness of the spacer 25 is set to a value corresponding to a difference between the active layer 21 of the VCSEL 20 and the light-receiving surface 31 of the photodetector 130 in height in the state where the active layer 21 and the photodetector 30 are placed on the flat surface. Accordingly, the active layer 21 of the VCSEL 20 mounted on the spacer 25 is raised by the thickness of the spacer 25. Therefore, the active layer 21 (P/N junction interface) of the VCSEL 20 and the light-receiving surface 31 (P/N junction interface) of the photodetector 30 are the same as each other in height from the mounting substrate 10 and thus, lie in the same plane.

As in the above-mentioned case, the lenses 51, 52 located above the VCSEL 20 and the photodetector 30, respectively, have the same surface curvature radius and lie in the same plane.

With such configuration, the distance between the active layer 21 of the VCSEL 20 and the lens 51 becomes equal to the distance between the light-receiving surface 31 of the photodetector 30 and lens 52, and the active layer 21 and the light-receiving surface 31 are located at focus positions of the lenses 51, 52, respectively.

Thereby, optical coupling between the VCSEL 20 and the optical fiber 61, and between the photodetector 30 and the optical fiber 62 can be achieved at the same time, thereby suppressing the optical coupling loss. As a result, the performances of the optical waveguide device can be improved. Furthermore, the heat radiation performance can be improved by making the spacer 25 from a material that is highly thermal conductive.

### Second Embodiment

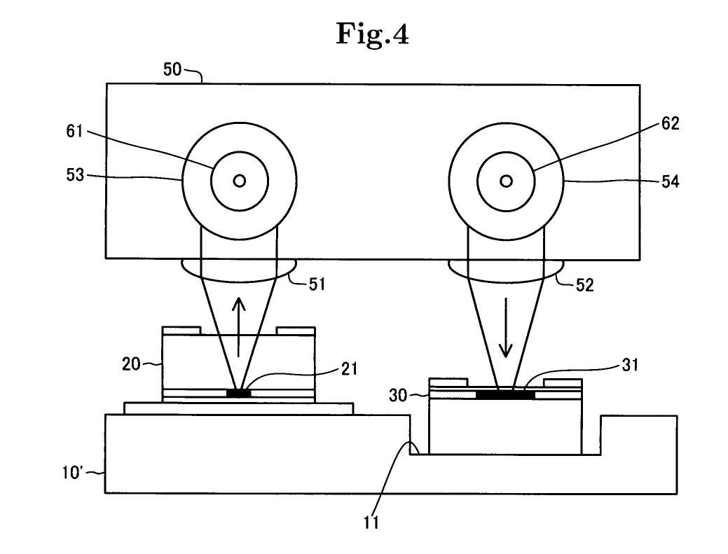

Next, Second embodiment of the present invention will be described with reference to FIG. 4. FIG. 4 is a view showing configuration of an optical waveguide device in this embodiment.

The optical waveguide device in this embodiment, as in First embodiment, includes the VCSEL 20 and the photodetector 30 that are mounted on a mounting substrate 10′ and a 45-degree mirror 50 equipped with the lenses 51 to 54 for optical coupling to optical fibers 61, 62. However, the spacer 25 is not provided.

In this embodiment, a recess 11 is formed on the mounting substrate 10′ of the optical transmission module and the photodetector 30 is mounted in the recess 11. Specifically, the recess 11 is formed so as to be depressed from the surface of the mounting substrate 10′, on which the VCSEL 20 is mounted, and a depth of the recess 11 is set to a value corresponding to a difference between the active layer 21 (P/N junction interface) of the VCSEL 20 and the light-receiving surface 31 (P/N junction interface) of the photodetector 30 in the state where the VCSEL 20 and the photodetector 30 are placed on a flat surface.

Since the photodetector 30 is mounted in the recess 11, the photodetector 30 is located at a lower position than the VCSEL 20 by the depth of the recess 11. As a result, the active layer 21 (P/N junction interface) of the VCSEL 20 and the light-receiving surface 31 (P/N junction interface) of the photodetector 30 are the same as each other in height from the mounting substrate 10′ and thus, lie in the same plane.

As in the above-mentioned case, the lenses 51, 52 located above the VCSEL 20 and the photodetector 30, respectively, have the same surface curvature radius and lie in the same plane.

With such configuration, the distance between the active layer 21 of the VCSEL 20 and the lens 51 becomes equal to the distance between the light-receiving surface 31 of the photodetector 30 and lens 52, and the active layer 21 and the light-receiving surface 31 are located at focus positions of the lenses 51, 52, respectively.

Thereby, optical coupling between the VCSEL 20 and the optical fiber 61, and between the photodetector 30 and the optical fiber 62 can be achieved at the same time, thereby suppressing the optical coupling loss. As a result, the performances of the optical waveguide device can be improved. Furthermore, the overall height of the module itself can be suppressed, thereby enabling miniaturization.

In addition to the above-mentioned configuration, the spacer 25 of any height in First embodiment may be mounted on the mounting substrate 10′, or in some cases, in the recess 11 and the VCSEL 20 or the photodetector 30 may be mounted on the spacer 25. Thereby, the height of the VCSEL 20 or the photodetector 30 can be adjusted so that the active layer 21 (P/N junction interface) of the VCSEL 20 and the light-receiving surface 31 (P/N junction interface) of the photodetector 30 are the same as each other in height.

### Third Embodiment

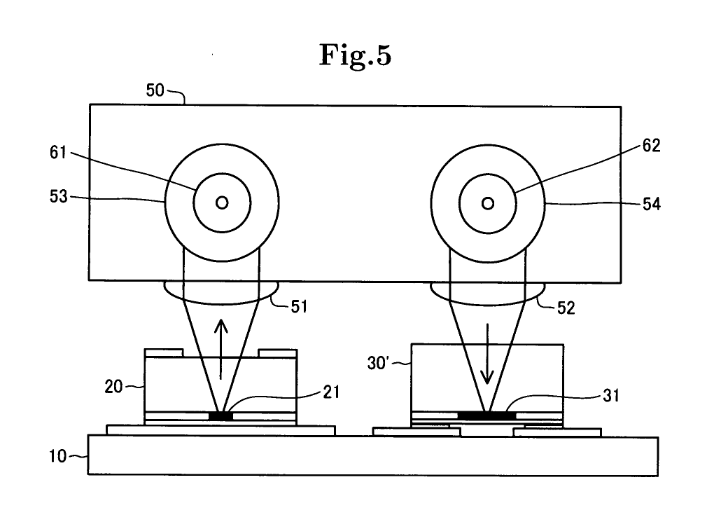

Next, Third embodiment of the present invention will be described with reference to FIG. 5. FIG. 5 is a view showing configuration of an optical waveguide device in this embodiment.

The optical waveguide device in this embodiment, as in First and Second embodiments, includes the VCSEL 20 and a photodetector 30′ that are mounted on the mounting substrate 10 and the 45-degree mirror 50 equipped with the lenses 51 to 54 for optical coupling to the optical fibers 61, 62.

The photodetector 30′ in this embodiment is a so-called back-illuminated photodetector, in which a substrate of the photodetector 30′ is transparent and the light-receiving surface 31 is laminated with the substrate. Thus, the photodetector 30′ receives an incident laser beam passing through the transparent substrate on the light-receiving surface 31. Accordingly, in the photodetector 30′, as shown in FIG. 5, the substrate of the photodetector 30′ is located on the side of the lens 52 and the side of the P/N junction interface as the light-receiving surface 31 is bonded to the mounting substrate 10 of the optical transmission module.

By using the photodetector 30′ with such configuration, as shown in FIG. 5, the active layer 21 (P/N junction interface) of the VCSEL 20 and the light-receiving surface 31 (P/N junction interface) of the photodetector 30′ are the same as each other in height and lie in the same plane.

As in the above-mentioned case, the lenses 51, 52 located above the VCSEL 20 and the photodetector 30′, respectively, have the same surface curvature radius and lie in the same plane.

As a result, the distance between the active layer 21 of the VCSEL 20 and the lens 51 becomes equal to the distance between the light-receiving surface 31 of the photodetector 30′ and the lens 52, and the active layer 21 and the light-receiving surface 31 are located at the focus positions of the lenses 51, 52, respectively.

Thereby, optical coupling between the VCSEL 20 and the optical fiber 61, and between the photodetector 30′ and the optical fiber 62 can be achieved at the same time, thereby suppressing the optical coupling loss. As a result, the performances of the optical waveguide device can be improved. Furthermore, since configuration of the module itself can be simplified, reduction of size and costs can be achieved.

In addition to the above-mentioned configuration, the spacer 25 of any height in First embodiment may be provided and the recess 11 of any depth in Second embodiment may be formed on the mounting substrate 10, and then, the VCSEL 20 or the photodetector 30′ may be mounted on the spacer 25 or in the recess 11. Thereby, height of the VCSEL 20 and the photodetector 30′ can be adjusted so that the active layer 21 (P/N junction interface) of the VCSEL 20 and the light-receiving surface 31 (P/N junction interface) of the photodetector 30′ are the same as each other in height.

### Fourth Embodiment

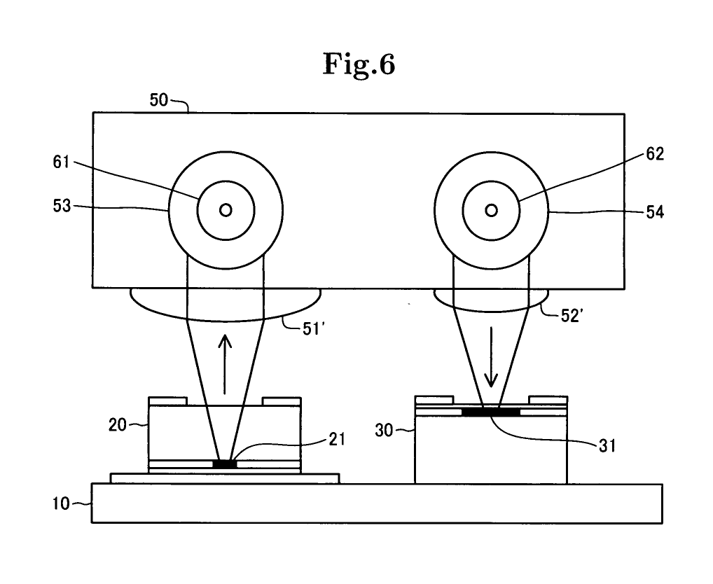

Next, Fourth embodiment in the present invention will be described with reference to FIG. 6. FIG. 6 is a view showing configuration of an optical waveguide device in this embodiment.

The optical waveguide device in this embodiment, as in First and Second embodiments, includes the VCSEL 20 and the photodetector 30 that are mounted on the mounting substrate 10 and the 45-degree mirror 50 equipped with lenses for optical coupling to the optical fibers 61, 62.

In this embodiment, as in the case shown in FIG. 2, the VCSEL 20 includes the GaAs/GaInAs active layer 21, a P/N junction interface side is bonded to the mounting substrate 10 and a laser beam is emitted from the side of the substrate of the VCSEL 20 itself. In the photodetector 30, the P/N junction interface side is located on the opposite side to the mounting substrate 10. For this reason, as in FIG. 6, in the state where the VCSEL 20 and the photodetector 30 are placed on the flat surface of the mounting substrate 10, the active layer 21 (P/N junction interface) of the VCSEL 20 and the light-receiving surface 31 (P/N junction interface) of the photodetector 30 differ from each other in height and do not lie in the same plane.

In this embodiment, lenses 51′, 52′ located above the VCSEL 20 and the photodetector 30, respectively, lie in the same plane. As distinct from the case in the above-mentioned embodiments, however, the lenses 51′,52′ have different surface curvature radii. In other words, the lenses 51′, 52′ have different focal lengths. However, the curvature radius of the lens 51′ corresponding to the VCSEL 20 is set so that the active layer 21 of the VCSEL 20 is located at the focus position and the curvature radius of the lens 52′ corresponding to the photodetector 30 is set so that the light-receiving surface 31 of the photodetector 31 is located at the focus position.

As described above, even if the distance between the active layer 21 of the VCSEL 20 and the lens 51 is different from the distance between the light-receiving surface 31 of the photodetector 31 and the lens 52, by configuring the lenses 51′, 52′ so as to have different curvature radii, that is, focal lengths, the active layer 21 of the VCSEL 20 and the light-receiving surface 31 of the photodetector 31 are located at the focus positions of the lenses 51′, 52′, respectively. Therefore, optical coupling between the VCSEL 20 and the optical fiber 61, and between the photodetector 30 and the optical fiber 62 can be achieved at the same time, thereby suppressing the optical coupling loss. As a result, the performances of the optical waveguide device can be improved. Furthermore, since configuration of the module itself can be simplified, reduction of size and costs can be achieved.

In addition to the above-mentioned configuration, the spacer 25 of any height in First embodiment may be provided and the recess 11 of any depth in Second embodiment may be formed on the mounting substrate 10, and then, the VCSEL 20 or the photodetector 30 may be mounted on the spacer 25 or in the recess 11. Thereby, height of the VCSEL 20 or the photodetector 30 can be adjusted so that the active layer 21 (P/N junction interface) of the VCSEL 20 and the light-receiving surface 31 (P/N junction interface) of the photodetector 30 are located at the focus positions of the lenses 51′, 52′, respectively.

### Fifth Embodiment

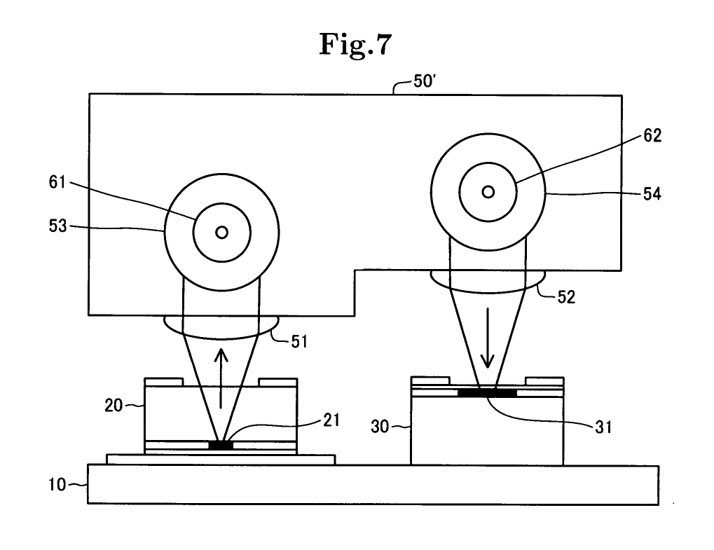

Next, Fifth embodiment of the present invention will be described with reference to FIG. 7. FIG. 7 is a view showing configuration of an optical waveguide device in this embodiment.

The optical waveguide device in this embodiment, as in Fourth embodiment, includes the VCSEL 20 and the photodetector 30 that are mounted on the mounting substrate 10 and a 45-degree mirror 50′ equipped with lenses for optical coupling to the optical fibers 61, 62.

The VCSEL 20 includes the GaAs/GaInAs active layer 21, a P/N junction interface side is bonded to the mounting substrate 10 and a laser beam is emitted from the side of the substrate of the VCSEL 20 itself. In the photodetector 30, the P/N junction interface side is located on the opposite side to the mounting substrate 10. Accordingly, as in FIG. 7, in the state where the VCSEL 20 and the photodetector 30 are placed on the flat surface of the mounting substrate 10, the active layer 21 (P/N junction interface) of the VCSEL 20 and the light-receiving surface 31 (P/N junction interface) of the photodetector 30 differ from each other in height and do not lie in the same plane.

In this embodiment, the lenses 51, 52 located above the VCSEL 20 and the photodetector 30, respectively, are formed so as to have the same curvature radius. As distinct from the case in the above-mentioned embodiments, however, they do not lie in the same plane. Specifically, the lens 51 corresponding to the VCSEL 20 is arranged closer to the mounting substrate 10 than the lens 52 corresponding to the photodetector 30. However, the distance between the lens 51 and the active layer 21 of the VCSEL 20 is equal to the distance between the lens 52 and the light-receiving surface 31 of the photodetector 31. As a result, the focus position of the lens 51 corresponding to the VCSEL 20 is located on the active layer 21 of the VCSEL 20 and the focus position of the lens 52 corresponding to the photodetector 30 is located on the light-receiving surface 31 of the photodetector 31.

As described above, by arranging the lenses 51, 52 having different distances from the mounting substrate 10 so that the distance between the lens 51 and the active layer 21 of the VCSEL 20 is equal to the distance between the lens 52 and the light-receiving surface 31 of the photodetector 31, optical coupling between the optical fiber 61 and the VCSEL 20 and between optical fiber 62 and the photodetector 30 can be achieved at the same time, thereby suppressing the optical coupling loss. As a result, the performances of the optical waveguide device can be improved. Furthermore, since configuration of the module itself can be simplified, reduction of size and costs can be achieved.

In addition to the above-mentioned configuration, the spacer 25 of any height in First embodiment may be provided and the recess 11 of any depth in Second embodiment may be formed on the mounting substrate 10, and then, the VCSEL 20 or the photodetector 30 may be mounted on the spacer 25 or in the recess 11. Thereby, height of the VCSEL 20 or the photodetector 30 can be adjusted so that the active layer 21 (P/N junction interface) of the VCSEL 20 and the light-receiving surface 31 (P/N junction interface) of the photodetector 30 are located at the focus positions of the lenses 51, 52, respectively.

Although a pair of VCSEL and photodetector are mounted in the optical waveguide devices (the optical transmission modules) in the above-mentioned embodiments, the present invention can be also applied to a multi-channel optical waveguide device (optical transmission module) having plural pairs of VCSELs and photodetectors.

Further, the optical waveguide devices (optical transmission modules) in the above-mentioned embodiments each are provided with the VCSEL with the GaAs/GaInAs strained quantum well, having the GaAs semiconductor substrate that is transparent for the laser beam of the oscillation wavelength range from 980 nm to 1100 nm. However, the present invention can be applied not only the above-mentioned devices equipped with the VCSEL with the GaAs/GaInAs strained quantum well, but also to an optical waveguide device (optical transmission module) equipped with a VCSEL with an InP/GaInAsP quantum well or an InP/GaInAs quantum well, having an InP semiconductor substrate that is transparent for the laser beam of an oscillation wavelength range from 1300 nm to 1640 nm.

Furthermore, although the 45-degree mirror 50 or 50′ is provided in the optical waveguide devices (optical transmission modules) in the above-mentioned embodiments, the 45-degree mirror need not be provided. That is, any configuration between the lenses 51, 52 and the optical fibers 61, 62 may be adopted.

1. An optical waveguide device comprising:
a light-emitting element having a light-emitting part for emitting a laser beam and a light-receiving element having a light-receiving part for receiving a laser beam, said elements being arranged on a mounting substrate in parallel with each other; and
a first lens for optically coupling the laser beam emitted from said light-emitting part to a first optical waveguide core and a second lens for optically coupling the laser beam conducted through a second optical waveguide core to said light-receiving part, said lenses being arranged in parallel with each other, wherein
said light-emitting element is a surface light-emitting semiconductor laser including a transparent semiconductor substrate laminated with an active layer as said light-emitting part, said surface light-emitting semiconductor laser emitting the laser beam from said active layer through said transparent semiconductor substrate,
in the case where said surface light-emitting semiconductor laser and said light-receiving element are placed on a flat surface, and said active layer and said light-receiving part differ from each other in height with respect the flat surface, said optical waveguide device is configured so that said active layer is located at a focus position of said first lens and said light-receiving part is located at a focus position of said second lens.

2. The optical waveguide device according to claim 1, wherein
said first lens and said second lens have the same surface curvature radius and lie in the same plane, and
by mounting said surface light-emitting semiconductor laser and said light-receiving element on said mounting substrate in different heights, said active layer of said surface light-emitting semiconductor laser and said light-receiving part of said light-receiving element lie in the same plane and have the same distance from said respective lenses.

3. The optical waveguide device according to claim 2, wherein
a spacer having a predetermined thickness is provided between said surface light-emitting semiconductor laser and said mounting substrate, and
said spacer is an electrical insulating material that is highly thermal conductive, and a conductive pattern electrically connected to said surface light-emitting semiconductor laser is formed on a surface of said spacer, on which said surface light-emitting semiconductor laser is mounted.

4. The optical waveguide device according to claim 2, wherein
in the mounting substrate, a region where said light-receiving element is mounted is depressed from a region where said surface light-emitting semiconductor laser is mounted.

5. The optical waveguide device according to claim 1, wherein
said light-receiving element is a photodetector having a transparent semiconductor substrate laminated with said light-receiving part, said photodetector allowing said light-receiving part to receive a laser beam emitted through said transparent semiconductor substrate,
said first lens and said second lens have the same surface curvature radius and lie in the same plane, and
by mounting said surface light-emitting semiconductor laser and said light-receiving element in the same plane on said mounting substrate, said active layer of said surface light-emitting semiconductor laser and said light-receiving part of said light-receiving element lie in the same plane and have the same distance from said respective lenses.

6. The optical waveguide device according to claim 1, wherein
said surface light-emitting semiconductor laser and said light-receiving element are mounted in the same plane on said mounting substrate,
said first lens and said second lens have the same surface curvature radius, said mounting substrate, and
by arranging said lenses in different heights from said mounting substrate, said active layer is located at the focus position of said first lens and said light-receiving part is located at the focus position of said second lens.

7. The optical waveguide device according to claim 1, wherein
said surface light-emitting semiconductor laser and said light-receiving element are mounted in the same plane on said mounting substrate,
said first lens and said second lens have different surface curvature radii,
by mounting said surface light-emitting semiconductor laser and said light-receiving element on said mounting substrate in the same height, said active layer is located at the focus position of said first lens and said light-receiving part is located at the focus position of said second lens.

8. An optical transmission device using the optical waveguide device according to claim 1.
